(19) United States
(12) Patent Application Publication
(10) Pub. No.: US 2007/0045027 A1
(43) Pub. Date: Mar. 1, 2007

(54) Collision detecting system

(75) Inventors: Toshihito Nonaka, Chiryu-city (JP); Minoru Fujioka, Anjo-city (JP); Shingo Wanami, Kariya-city (JP); Satoru Takehara, Obu-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/512,766

(22) Filed: Aug. 30, 2006

(30) Foreign Application Priority Data
Aug. 31, 2005 (JP) 2005-252588

(51) Int. Cl. B60K 28/10; B60Q 1/00; G01L 7/08

(52) U.S. Cl. 180/274; 73/715; 340/436

(57) ABSTRACT

A collision detecting system is provided to detect a collision of a vehicle based on a pressure variation in a substantially closed space which is arranged at a periphery portion of the vehicle. The collision detecting system has a sensing unit which detects a pressure in the space. The sensing unit is arranged at the vehicle in such a manner that a detection direction of the sensing unit is slanted with respect to the direction of an impact on the vehicle due to the collision. Therefore, the vehicle vibration excited by the impact can be restricted from influencing the detection result of the pressure in the space by the sensing unit, thus improving the detection of the vehicle collision.

### CROSS REFERENCE TO RELATED APPLICATION

This application is based on a Japanese Patent Application No. 2005-252588 filed on Aug. 31, 2005, the disclosure of which is incorporated herein by reference.

### FIELD OF THE INVENTION

The present invention relates to a collision detecting system which detects a collision with an improved accuracy with respect to an influence of a vibration.

### BACKGROUND OF THE INVENTION

Generally, a vehicle is provided with a passenger protecting system for protecting passengers in a collision of the vehicle. The passenger protecting system has, for example, an airbag device for deploying an airbag to protect the head portion or the like of the passenger, and/or a pre-tensioner device for taking up a slack of a seat belt of the vehicle.

The airbag device and the pre-tensioner device are controlled by a control unit such as an ECU. The ECU performs a determination of a vehicle collision based on signals from sensors mounted to the vehicle, and actuates the airbag device and the pre-tensioner device when the vehicle collision is determined.

For example, the sensor for detecting the vehicle collision can be constructed of an acceleration sensor for detecting an acceleration variation of the vehicle, a touch sensor which is attached to a periphery portion of the vehicle to detect a stress thereat, a pressure sensor for detecting a pressure variation in a space formed at the periphery portion of the vehicle, or the like.

It is desirable that the passenger can be protected not only from the vehicle collision in the vehicle traveling direction (i.e., vehicle front-rear direction), but also from a side collision of the vehicle which causes a vehicle-width-direction impact on the vehicle.

For example, as disclosed in JP-2-249740A, the airbag device for protecting the passenger from the side collision of the vehicle is provided with a side airbag, which can be deployed according to detection signals of the pressure sensor. The pressure sensor detects the variation of an inner pressure of the vehicle door.

However, in this case, because the pressure sensor is mounted to the vehicle door to detect the inner pressure thereof, the vibration information of the vehicle which is excited by the impact load of the collision will be included in the detection signals of the pressure sensor. Specifically, when the vehicle collision occurs, the impact load due to the collision is transmitted to the vehicle body such as the vehicle door. As a result, the vehicle door is excited to vibrate, and the vibration will be transferred to the pressure sensor. According to the conventional side-airbag system, the vibration of the vehicle door is added to the inner pressure thereof to be detected by the pressure sensor, thus causing an error in the collision determination which is performed based on the detection signals of the pressure sensor.

Although the error can be reduced by a correction of the detection signals of the pressure sensor by the ECU which performs the vehicle collision determination, the responsivity is inferior and processing time is needed, which is undesirable.

### SUMMARY OF THE INVENTION

In view of the above-described disadvantages, it is an object of the present invention to provide a collision detecting system in which an error in detecting a collision is reduced.

According to the present invention, the collision detecting system for a vehicle has a sensing unit for detecting a pressure in a substantially closed space, which is arranged at a periphery portion of the vehicle. A collision of the vehicle is detected, based on a variation of the pressure in the space which is measured by the sensing unit. The sensing unit is arranged at the vehicle in such a manner that a direction perpendicular to a detection surface of the sensing unit intersects a traveling surface of the vehicle. The traveling surface is tangential to a road contact portion of wheels of the vehicle.

In this case, the direction perpendicular to the detection surface of the sensing unit corresponds to the detection direction of the sensing unit. The detection direction of the sensing unit intersects the traveling surface of the surface. That is, the detection direction intersects the direction of the impact on the vehicle due to the collision. Therefore, at least a part of the vehicle vibration which is transferred to the sensing unit is not measured by the sensing unit, thus improving the determination of the vehicle collision which is performed based on the detection result of the pressure in the space.

Preferably, the direction perpendicular to the detection surface of the sensing unit is substantially perpendicular to the traveling surface of the vehicle.

Thus, the vehicle vibration which is transferred to the sensing unit can be substantially restricted from influencing the detection result of the pressure in the space from the sensing unit. Accordingly, the determination of the vehicle collision can be further improved.

### BRIEF DESCRIPTION OF THE DRAWINGS

Other objects, features and advantages of the present invention will become more apparent from the following detailed description made with reference to the accompanying drawings, in which:

FIG. 1A is a partially sectional view showing a construction of a pressure detecting device according to a first embodiment of the present invention, and FIG. 1B is a schematic view showing a construction of a pressure detecting member of the pressure detecting device in FIG. 1A;

FIG. 2A is a schematic view showing a construction of a collision detecting system which is mounted to a vehicle according to the first embodiment, and FIG. 2B is an enlarged partially-sectional view showing a part IIB in FIG. 2A;

FIG. 3 is a graph showing a detection result of a side collision by the pressure detecting device according to the first embodiment;

FIG. 4 is a graph showing a vehicle vibration excited by an impact load due to the side collision according to the first embodiment;

FIG. 5 is a partially sectional view showing a construction of a pressure detecting device according to a second embodiment of the present invention;

FIG. 6 is a partially sectional view showing a construction of a pressure detecting device according to a comparison example;

FIG. 7A is a schematic view showing a construction of a collision detecting system having the pressure detecting device according to the comparison example, and FIG. 7B is an enlarged partially-sectional view showing a part VIIB in FIG. 7A;

FIG. 8 is a graph showing a detection result of a side collision by the pressure detecting device according to the comparison example; and

FIG. 9A is a schematic view showing a construction of a pressure detecting device according to a third embodiment of the present invention, and FIG. 9B is an enlarged partially-sectional view showing a part IXB in FIG. 9A.

### DETAILED DESCRIPTION OF THE EXAMPLE EMBODIMENTS

### First Embodiment

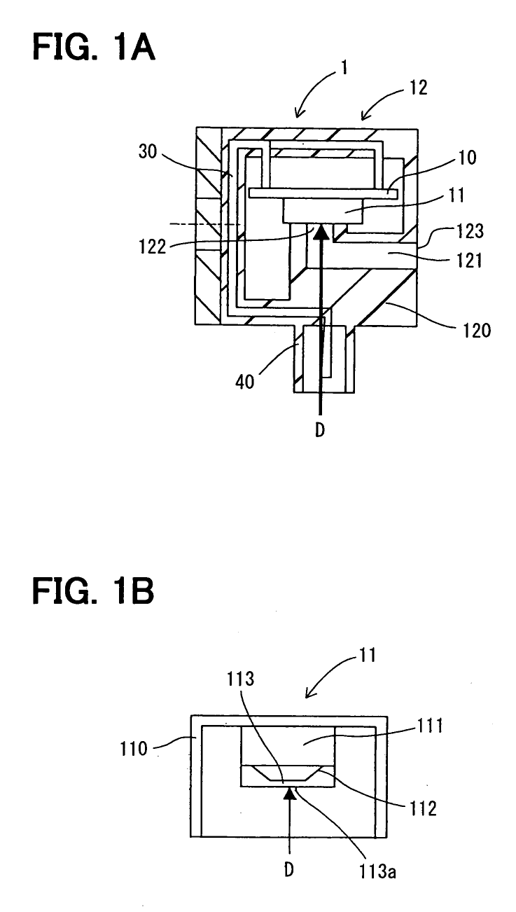

A collision detecting system according to a first embodiment of the present invention will be described with reference to FIGS. 1A-4. The collision detecting system can be suitably used for a vehicle, for example.

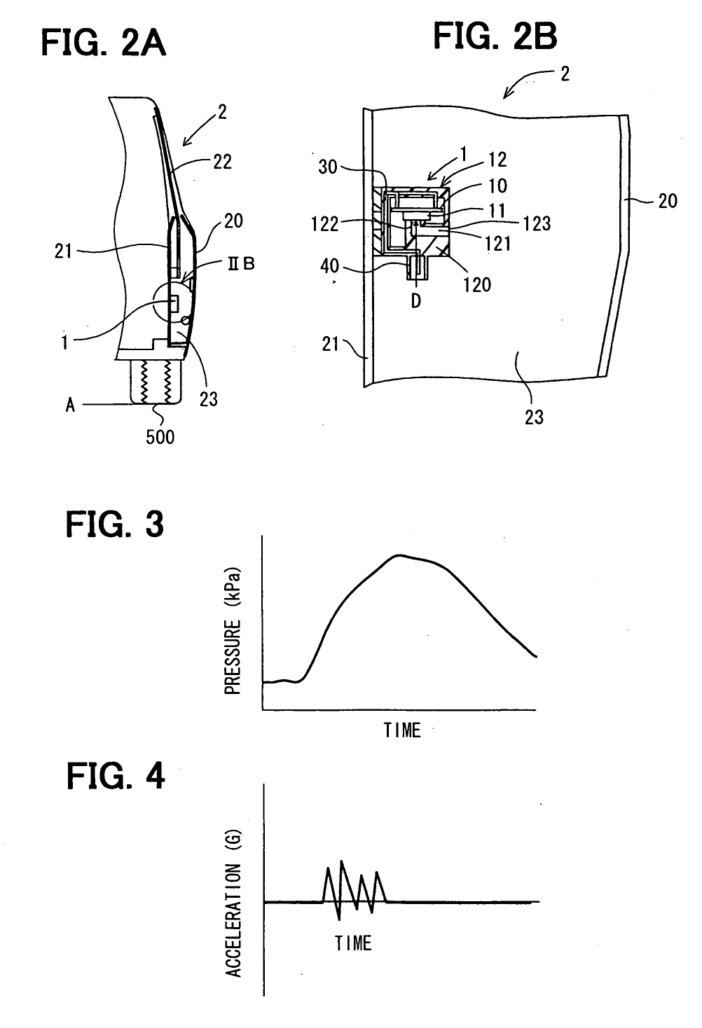

Referring to FIGS. 2A and 2B, the collision detecting system has a pressure detecting device 1 for detecting an inner pressure of a door 2 (i.e., pressure in space 23 of interior of door 2) of the vehicle. The door 2 has an outer panel 20, an inner panel 21 and a window glass 22. The outer panel 20 constructs a part of an exterior member of the vehicle. The inner panel 21 constructs a part of an interior member of the vehicle. That is, the inner panel 21 is positioned at the side of a passenger compartment of the vehicle.

The door 2 has therein a substantially closed space 23 between the outer panel 20 and the inner panel 21. The space 23 has a small communication (fluid communication) with the exterior of the door 2. When the pressure (air pressure) of the exterior of the door 2 varies, the pressure (air pressure) in the space 23 of the interior of the door 2 also varies. The space 23 is formed in such a manner that the pressure in the space 23 (i.e., inner pressure of door 2) will increase when the capacity of the space 23 sharply varies.

The pressure detecting device 1 includes a circuit board 10, a pressure detecting member 11 mounted to the circuit board 10, and a sensor housing member 12 for accommodating therein the circuit board 10 and the pressure detecting member 11. In this case, the pressure detecting member 11 is arranged in such a manner that the detection direction D of the pressure detecting member 11 is substantially perpendicular to the surface of the circuit board 10. The pressure detecting device 1 can be also provided with a terminal 30 and a connector 40 for signal-communication with the exterior.

The pressure detecting member 11 has a substantially sink-shaped housing 110, a pedestal 111 and a sensing unit 112 which are housed in the housing 110. The housing 110 can be made of a resin or the like. The pedestal 111, being arranged in the housing 110, is attached to an end surface (i.e., upper end surface of housing 110 shown in FIG. 1B) of the housing 110. The sensing unit 112 is fixedly mounted to the pedestal 111.

The sensing unit 112 is provided with a diaphragm 113, and a resistance circuit (not shown) for measuring a gauge resistance formed at a surface 113a (detection surface) of the diaphragm 113. That is, the pressure detecting member 11 is constructed of a diaphragm-typed pressure sensor.

When a pressure in the thickness direction of the diaphragm 113 is applied to the diaphragm 113, the diaphragm 113 will vibrate in the thickness direction thereof. Thus, a compression stress and a tensile stress occur respectively at a center portion and a periphery portion of the diaphragm 113, so that the gauge resistance of the sensing unit 112 varies. The gauge resistance is detected via the resistance circuit. Therefore, the pressure exerted to the diaphragm 113 can be detected based on the variation amount of the diaphragm 113, which is calculated according to the change of the gauge resistance.

In this case, the detection direction D of the sensing unit 112 (diaphragm 113) corresponds to the thickness direction of the diaphragm 113, which is perpendicular to the detection surface 113a thereof.

The circuit board 10 and the pressure detecting member 11 are fixedly accommodated in the sensor housing member 12. The pressure detecting device 1 can be fixed to the inner panel 21 of the door 2, for example. In this case, the pressure detecting device 1 is mounted to the vehicle in such a manner that the detection direction D of the sensing unit 112 of the pressure detecting member 11 is substantially perpendicular to a traveling surface A of the vehicle.

In this case, the traveling surface A of the vehicle is a virtual surface which is tangential to a road contact portion 500 of the wheels of the vehicle. When the vehicle travels, the traveling surface A of the vehicle corresponds to the road surface (e.g., horizontal surface). The direction of the impact load applied to the vehicle due to the collision is parallel to the road surface (i.e., vehicle traveling surface).

For example, the detection direction D of the sensing unit 112 of the pressure detecting member 11 mounted at the vehicle can be arranged in the substantially vertical direction, in the case where the traveling surface A of the vehicle is a substantially horizontal surface. Specifically, the sensing unit 112 is arranged so that the surface 113a of the diaphragm 113 of the sensing unit 112 faces the vertical direction and extends in the substantially horizontal direction.

Moreover, in the sensor housing member 12, the circuit board 10 and the pressure detecting member 11 are arranged in such a manner that the diaphragm 113 of the sensing unit 112 is communicated with the exterior of the sensor housing member 12. Specifically, the sensor housing member 12 has a substantially box-shaped housing body 120, which is provided with a pressure introduction aperture 121. One end of the pressure introduction aperture 121 is provided with an opening portion 123 arranged at a flank surface of the housing body 120, and other end of the pressure introduction aperture 121 is provided with an opening portion 122 which faces the diaphragm 113 of the sensing unit 112 of the pressure detecting member 11.

The housing body 120 has a vehicle mounting side, through which the pressure detecting device 1 is attached to the door 2 of the vehicle. The opening portion 123 of the pressure introduction aperture 121 can be provided for the housing body 120 at an opposite side to the vehicle mounting side of the housing body 120.

The pressure introduction aperture 121 can extend from the opening portion 122 toward the vertically lower side in the case where the vehicle traveling surface A is the horizontal surface, and then turn to the flank surface of the housing body 120 to have the opening portion 123 at the flank surface. That is, the pressure introduction aperture 121 is provided with a nonlinear axis in the extending direction thereof.

In this case, the opening portion 122 of the other end of the pressure introduction aperture 121 is opened adjacently to the surface 113a of the diaphragm 113 of the sensing unit 112.

Thus, the pressure of the exterior (i.e., space 23 of interior of door 2) of the sensor housing member 12 is applied to the diaphragm 113 via the pressure introduction aperture 121. A seal member (not shown) can be arranged between the opening portion 122 of the other end of the pressure introduction aperture 121 and the surface 113a of the diaphragm 113.

According to this embodiment, the collision detecting system further has a calculating unit (not shown) for calculating the pressure in the space 23 of the interior of the door 2 based on pressure signals, which are inputted thereto from the pressure detecting device 1. The calculating unit can be constructed of a calculating circuit integrated with the pressure detecting device 1.

As shown in FIGS. 2A and 2B, the pressure detecting device 1 can be attached to a surface of the inner panel 21 of the door 2 in such a manner that the thickness direction of the diaphragm 113 is provided with a predetermined orientation. This surface (where pressure detecting device 1 is mounted) of the inner panel 21 is positioned at the side of the space 23 of the interior of the door 2.

Next, the detection of a collision of the vehicle via the collision detecting system will be described.

For example, when there occurs a side collision (which causes vehicle-width-direction impact on vehicle) between an obstacle and the door 2 of the vehicle, the obstacle contacts the outer panel 20 of the door 2 and presses the outer panel 20 toward the inner side of the vehicle. Thus, the outer panel 20 is deformed to protrude toward the side of the inner panel 21. Because the impact due to the collision is not directly applied to the inner panel 21, the shape of the inner panel 21 can be substantially maintained.

Therefore, in the case where the outer panel 20 is deformed due to the collision, the capacity (i.e., volume) of the space 23 of the interior of the door 2 will be sharply reduced. The amount of fluid communication between the space 23 and the exterior of the door 2 is relatively small, and as such, the pressure in the space 23 increases significantly. The pressure in the space 23 is applied to the diaphragm 113 through the pressure introduction aperture 121, to be detected by the pressure detecting device 1.

As described above, the pressure detecting device 1 mounted at the inner panel 21 is provided with the sensing unit 112 which has the detection direction D in the substantially vertical direction or the like. Therefore, the pressure detecting device 1 detects the pressure merely in the substantially vertical direction.

In the case of the collision of the door 2 of the vehicle, the impact load due to the collision will be transmitted toward the whole vehicle from the door 2. The inner panel 21 and the outer panel 20 of the door 2 are excited by the impact load to vibrate in the direction of the impact load.

Because the impact load applied to the vehicle is substantially parallel to the ground surface (e.g., horizontal surface), the vibration of the door 2 will not be detected by the pressure detecting device 1 provided with the detection direction D which is substantially perpendicular to the vehicle traveling surface A (e.g., which is in substantially vertical direction).

The pressure signals (detected by sensing unit 112) from the pressure detecting device 1 are sent to the calculating unit so that the pressure in the space 23 is calculated. Thus, the pressure variation in the space 23 of the interior of the door 2 can be acquired.

FIG. 3 shows the detection result of the pressure detecting device 1 in the case of the side collision of the door 2 of the vehicle according to this embodiment. FIG. 4 shows the vibration of the door 2 excited by the impact load due to the side collision.

As shown in FIGS. 3 and 4, the vibration of the door 2 excited by the impact load from the side collision is hardly detected by the pressure detecting device 1 of the collision detecting system of this embodiment, because the detection direction D of the pressure detecting device 1 is in the substantially vertical direction which is perpendicular to the vibration direction (i.e., substantially horizontal direction) of the door 2.

That is, the vehicle vibration excited by the impact load or the like is substantially restricted from influencing the pressure detected by the pressure detecting device 1. Therefore, according to this embodiment, the determination of the vehicle collision based on the detection of the pressure variation in the space 23 can be improved.

In this case, the signal of the pressure in the space 23 which is calculated by the calculating unit can be sent to a passenger protecting device, which will actuate a side airbag or the like to protect the passenger in the side collision of the vehicle. For example, the signal of the pressure in the space 23 which is calculated by the calculating unit can be sent to an airbag ECU (A/B ECU) of the passenger protecting device. The airbag ECU having a CPU controls the deploy of the side airbag according to the pressure signal. According to this embodiment, the detection accuracy of the vehicle collision can be improved so that the passenger can be properly protected.

### Second Embodiment

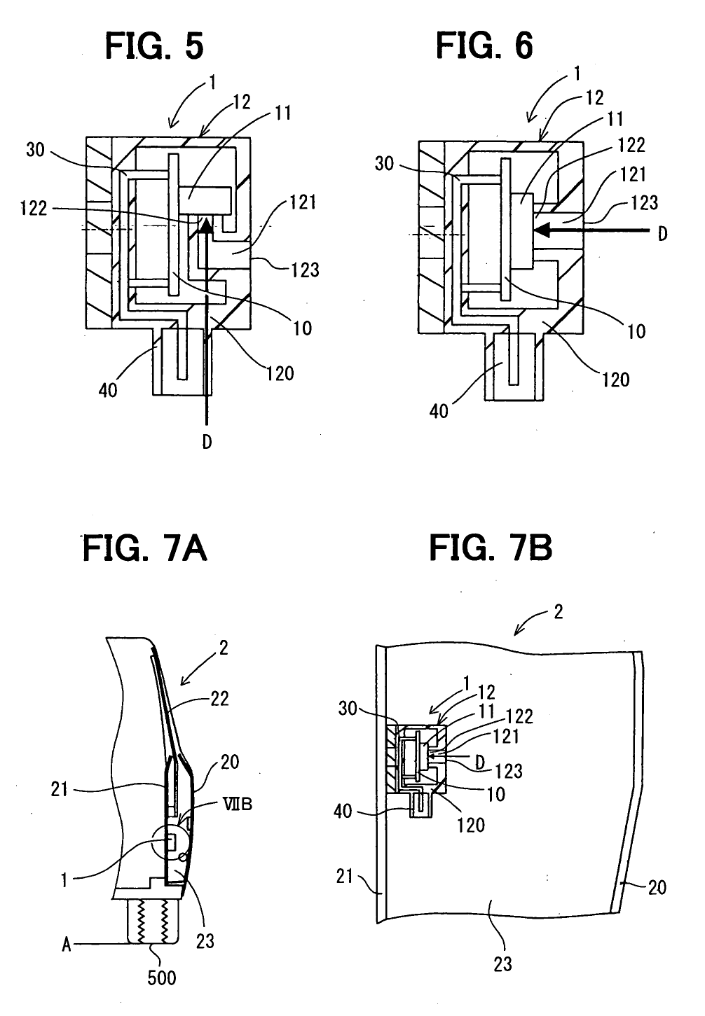

According to a second embodiment of the present invention with reference to FIG. 5, the pressure detecting member 11 of the pressure detecting device 1 is mounted in such a manner that the detection direction D of the pressure detecting member 11 is substantially parallel to the surface of the circuit board 10.

That is, the relative position between the pressure detecting member 11 and the circuit board 10 is different from that in the first embodiment, where the detection direction D of the pressure detecting member 11 is substantially perpendicular to the surface of the circuit board 10.

About the collision detecting system, what has not been described in the second embodiment is the same with the first embodiment. The collision detecting system according to the second embodiment has the same effect with that according to the first embodiment.

A conventional collision detecting system will be described with reference to FIGS. 6-8, as a comparison example with that of the present invention.

As shown in FIG. 6, the collision detecting system has the pressure detecting device 1, which is provided with the circuit board 10, the pressure detecting member 11 and the sensor housing member 12. The pressure detecting member 11 is arranged in such a manner that the detection direction D of the pressure detecting member 11 is substantially perpendicular to the surface of the circuit board 10. The pressure detecting member 11 has the substantially sink-shaped housing 110, the pedestal 111 and the sensing unit 112.

The circuit board 10 and the pressure detecting member 11 are fixedly accommodated in the sensor housing member 12. As shown in FIGS. 7A and 7B, the pressure detecting device 1 is mounted at the door 2 in such a manner that the detection direction D of the sensing unit 112 of the pressure detecting member 11 is in the substantially horizontal direction. Specifically, the detection surface 113a of the diaphragm 113 of the sensing unit 112 is arranged to extend in the substantially vertical direction.

Moreover, the pressure introduction aperture 121 of the sensor housing member 12 extends in the substantially horizontal direction from the opening portion 122 to the opening portion 123. That is, the pressure introduction aperture 121 extends substantially linearly.

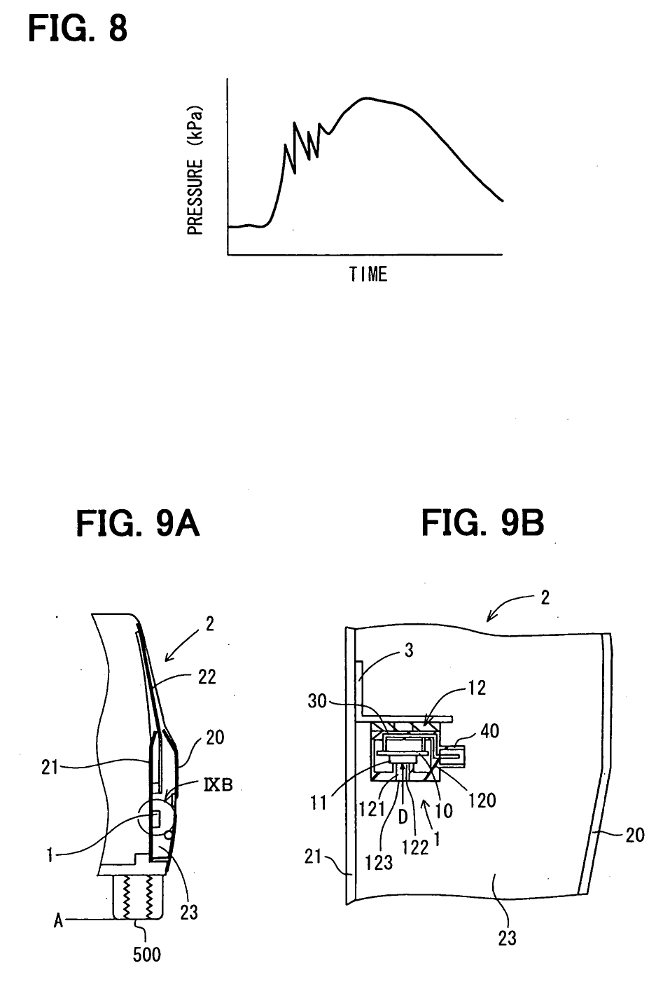

In this case, as shown in FIGS. 7A and 7B, the pressure detecting device 1 is attached to the door 2 of the vehicle in such a manner that the detection direction D of the pressure detecting member 11 (i.e., detection direction of sensing unit 112) is in the substantially horizontal direction. As shown in FIG. 8, the vehicle vibration excited by the impact load will be measured by the pressure detecting device 1 along with the pressure in the space 23, because the detection direction D of the pressure detecting device 1 corresponds to the direction of the impact load applied to the vehicle due to the side collision. Therefore, according to the conventional collision detecting system, the accuracy of the collision detection based on the pressure in the space 23 detected by the pressure detecting device 1 will be deteriorated.

### Third Embodiment

A third embodiment of the present invention will be described with reference to FIGS. 9A and 9B.

In this case, the pressure detecting device 1 is attached to a substantially L-shaped stay 3 which is fixed to the inner panel 21 of the door 2. That is, the stay 3 has two portions which are substantially perpendicular to each other and respectively fixed to the inner panel 21 of the door 2 and the vehicle mounting side of the pressure detecting device 1, so that the detection direction D of the pressure detecting device 1 is in the substantially vertical direction.

According to this embodiment, the detection direction D of the pressure detecting device 1 is in the substantially vertical direction which is perpendicular to the direction of the impact load applied to the vehicle due to the collision. Thus, the vehicle vibration excited by the impact load from the collision is hardly detected by the pressure detecting device 1. Therefore, the collision detecting system according to the third embodiment has the same effect with that of the first embodiment.

According to the third embodiment, the sensor housing member 12 of the pressure detecting device 1 is provided with the pressure introduction aperture 121, which extends substantially linearly from the opening portion 122 to the opening portion 123. The pressure detecting device 1 is attached to the door 2 via the substantially L-shaped stay 3. Thus, the pressure detecting device 1 with the conventional construction can be used, so that it is unnecessary to anew manufacture a pressure sensor. Thus, the collision detecting system can be provided with a lowered cost.

About the collision detecting system, what has not been described in the third embodiment is the same with the first embodiment.

### Other Embodiments

Although the present invention has been fully described in connection with the preferred embodiments thereof with reference to the accompanying drawings, it is to be noted that various changes and modifications will become apparent to those skilled in the art.

For example, the detection direction D of the pressure detecting member 11 (sensing unit 112) can be also slanted with respect to the impact load direction (e.g., horizontal direction) of the collision. That is, the angle between the detection direction D of the sensing unit 112 and the traveling surface A (to which impact load direction is parallel) of the vehicle can be set smaller than or equal to 90°.

In this case, the information of the detection-direction component of the vehicle vibration excited by the impact load (due to collision) is partially included in the detection signal of the pressure detecting device 1. However, in the case where the detection-direction component of the vehicle vibration detected by the pressure detecting device 1 is sufficiently small, the influence on the detection result of the collision detecting system can be ignored.

In this case, because the detection characteristic of the collision detecting system is required according to conditions such as the vehicle rigidity and the amplitude of the impact load (that is, detection characteristic of collision detecting system is variable), the angle between the detection direction D of the pressure detecting device 1 and the impact load direction (i.e., horizontal direction) is not defined.

For example, in the case the impact on the vehicle due to the collision is great (i.e., the case where pressure in space 23 of door 2 has a large variation during a short period), it can be determined that there occurs a major accident so that a rapid detection of the collision is required. In this case, it is desirable that the vehicle vibration excited by the impact due to the collision is excluded from the detection signal of the pressure (in space 23) by the pressure detecting device 1.

In the above-described embodiments, the substantially-closed space 23 is arranged in the door 2 of the vehicle. However, the vehicle can be also provided with the substantially-closed space 23 at a periphery part thereof other than the door 2, so that the vehicle collision such as a head-on collision can be detected.

Such changes and modifications are to be understood as being in the scope of the present invention as defined by the appended claims.

What is claimed is:

1. A collision detecting system for a vehicle, the collision detecting system comprising
a sensing unit for detecting a pressure in a substantially closed space which is arranged at a periphery portion of the vehicle, a collision of the vehicle being detected based on a variation of the pressure in the space, wherein
the sensing unit is arranged at the vehicle in such a manner that a direction perpendicular to a detection surface of the sensing unit intersects a traveling surface of the vehicle, the traveling surface being tangential to a road contact portion of wheels of the vehicle.

2. The collision detecting system according to claim 1, wherein the sensing unit is arranged at the vehicle in such a manner that the direction perpendicular to the detection surface of the sensing unit intersects a horizontal direction.

3. The collision detecting system according to claim 1, wherein the sensing unit is arranged at the vehicle in such a manner that the direction perpendicular to the detection surface of the sensing unit is substantially perpendicular to the traveling surface-of the vehicle.

4. The collision detecting system according to claim 2, wherein the sensing unit is arranged at the vehicle in such a manner that the direction perpendicular to the detection surface of the sensing unit is in a substantially vertical direction.

5. The collision detecting system according to claim 1, further comprising
a calculating unit for calculating the pressure in the space according to detection signals from the sensing unit.

6. The collision detecting system according to claim 1, wherein the space is arranged in a door of the vehicle.

7. The collision detecting system according to claim 1, further comprising
a passenger protecting device for protecting a passenger in the vehicle when the collision of the vehicle is detected according to detection signals from the sensing unit.

8. The collision detecting system according to claim 1, wherein
the sensing unit has a diaphragm for detecting the pressure which is applied to a surface of the diaphragm in a thickness direction of the diaphragm, the surface of the diaphragm being the detection surface of the sensing unit.

9. The collision detecting system according to claim 8, further comprising
a housing body in which the sensing unit is mounted, wherein
the housing body has therein a pressure introduction aperture aperture with a nonlinear axis, the pressure in the space being applied to the diaphragm through the pressure introduction aperture.

10. The collision detecting system according to claim 8, further comprising:
a housing body in which the sensing unit is mounted; and
a substantially L-shaped stay with which the housing body is fixed to the vehicle, wherein
the housing body has a pressure introduction aperture which extends substantially linearly in the housing body, the pressure in the space being applied to the diaphragm through the pressure introduction aperture.

11. The collision detecting system according to claim 6, wherein the sensing unit is attached to the door of the vehicle.
